(19) United States
(12) Patent Application Publication
(10) Pub. No.: US 2016/0200254 A1
(43) Pub. Date: Jul. 14, 2016

(54) Method and System for Preventing Blind Spots

(71) Applicant: BSR Technologies Group, Happy Valey, OR (US)

(72) Inventor: Brian Raab, Happy Valley, OR (US)

(73) Assignee: BSR Technologies Group, Portland, OR (US)

(21) Appl. No.: 14/992,514

(22) Filed: Jan. 11, 2016

Related U.S. Application Data
(60) Provisional application No. 62/102,228, filed on Jan. 12, 2015.

(51) Int. Cl. B60R 1/00; H04N 5/262; H04N 5/247

(52) U.S. Cl. CPC B60R 1/00; H04N 5/247; H04N 5/2628; B60R 2300/105; B60R 2300/802

(57) ABSTRACT

A means for decreasing or eliminating blind spots through the combination of a flexible electronic display and exterior cameras which allow the user to see if anything is occupying a traditional blind spot. Information received from the exterior cameras is combined through the use of photo-stitching allowing for presentation of a wider range of view than that presented by a single camera and providing the perception that the viewer is able to directly view spaces near the car that are in a blind spot such as cars in adjacent lanes near the rear quarter of the car and items that are too low to see.

### CROSS-REFERENCE TO RELATED APPLICATIONS

This application claims benefit of U.S. Provisional Patent Application No. 62/102,228 filed Jan. 12, 2015, which is incorporated herein by reference in its entirety.

### BACKGROUND

Designing a vehicle requires a balance between form and function with every decision requiring a compromise; fuel economy vs. acceleration, understeering vs. oversteering, efficiency vs. safety. There are even conflicts between different aspects of the same objective. For example, a reduction in pillar thickness would decrease blind spots, however, narrower pillars cannot be made as strong as thicker pillars and airbags require pillars of a particular thickness. There is therefore a safety conflict between preventing accidents and protecting individuals in case of an accident.

A blind spot is any area that cannot be seen due to an obstruction within a field of view. Blind spots may occur in front of the driver when the A-pillar (also called the windshield pillar), side-view mirror, and interior rear-view mirrors block a driver's view of the road. Front end blind spots are frequently influenced by the distance between the driver and the pillar, the thickness of the pillar, the angle of the pillar in a vertical plane side view, the angle of the pillar in a vertical plane front view, the form of the pillar (straight or arc-form), the angle of the windshield, the height of the driver in relation to the dashboard, and the speed of the opposite car. Behind the driver there are additional pillars, headrests, passengers, and cargo that may reduce rear and side visibility. While side view mirrors provide some assistance in reducing lateral blind spots, most mirrors have a blind-spot between the area lateral to the side-view mirror's field and behind the driver's direct lateral vision so that at some point an adjacent vehicle disappears from the viewing range of the mirror. There is a similar blind spot on the passenger's side of the vehicle. These blind spots can be between half a car length to a car length behind the front of the car creating a hazard when turning, merging, or changing lanes.

While technological solutions such as back-up cameras and active blind spot monitoring have been introduced, there are still more than 800,000 blind-spot-related accidents every year according to the National Highway Traffic Safety Administration. There is therefore an unmet need for an alternate means of eliminating blind spots.

### BRIEF SUMMARY

Provided herein is a means for decreasing or eliminating blind spots in a motor vehicle. One or more cameras are placed on an exterior portion of the vehicle or an interior portion of a vehicle facing through a transparent surface such as the on the back of the rear view mirror. Captured images are displayed on flexible electronic displays placed on surfaces of the interior of the passenger compartment. A microprocessor in communication with one or more of the cameras and one or more of the display screens continuously processes images received from the camera(s) and transmits the images from the camera(s) to the designated flexible electronic screen on the interior of the passenger compartment. In some embodiments, the flexible electronic screens display the images taken immediately exterior of the motorized vehicle corresponding to the interior placement of the flexible electronic screen in real time allowing for a consistent view between the images on the flexible electronic screens and a transparent surface adjacent to the flexible electronic screens such as a window. The cameras may take images sequentially or substantially simultaneously. In some embodiments, images are recorded continuously. In other embodiments, images may be recorded and/or displayed intermittently.

Each of the cameras placed on the vehicle comprises a lens and a sensor. Each camera may have the same or different types of lens and each group of cameras in a particular location may have the same or different types of lenses such as, but not limited to, an infrared lens, standard lens, medium telephoto lens, a wide angle lens, telephoto and/or other specialist lens.

In some embodiments, images taken by a plurality of cameras may be combined using an overlapping capture region to form a single image. The images may be taken substantially simultaneously or at different times.

While any flexible electronic screen may be used to display the images, in some embodiments, the flexible screen is an active-matrix organic light-emitting diode (AMOLED) screen. In other embodiments, the flexible screen is an OLED screen.

In some embodiments, the flexible electronic display(s) attached to the interior of the passenger compartment of a motorized vehicle may be perforated at one or more points allowing for them to break away in the event of an airbag deployment.

These and other embodiments, features and potential advantages will become apparent with reference to the following description.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an exterior view of a vehicle depicting a blind spot eliminator.

FIG. 2 is an exterior of a vehicle showing an embodiment of a blind spot eliminator.

FIG. 3 depicts an exterior view of an embodiment of a car with a blind spot eliminator system.

FIG. 4 is an interior of a vehicle showing an embodiment of a blind spot eliminator.

FIG. 5 is a system diagram of an embodiment of a blind spot eliminator.

FIG. 6 is an action flow diagram of an embodiment of a blind spot eliminator.

FIG. 7 is a flow chart of an embodiment of a blind spot eliminator.

FIG. 8 is a system diagram of a system for analyzing blind spots.

FIG. 9 is an action flow diagram of a system for analyzing blind spots.

FIG. 10 is a flow chart of an embodiment of a system for analyzing blind spots.

FIG. 11 is a figure an embodiment of a blind spot eliminator system.

FIG. 12 is a system diagram of an embodiment of a blind spot eliminator.

FIG. 13 is an action flow diagram of an embodiment of a blind spot eliminator.

FIG. 14 is a flow chart of an embodiment of a blind spot eliminator.

FIG. 15 is a figure depicting an embodiment of a display.

### DETAILED DESCRIPTION

### Glossary

“AMOLED” in this context refers to Active-Matrix Organic Light-Emitting Diode.

“Blind Spot” in this context refers to an area around the vehicle that cannot be directly observed by the driver while at the controls.

“BRIEF” in this context refers to Binary Robust Independent Elementary Features (BRIEF) keypoint descriptor algorithm.

“Bundle adjustment” in this context refers to simultaneously refining the 3D coordinates describing the scene geometry as well as the parameters of the relative motion and the optical characteristics of the camera(s) employed to acquire the images according to an optimality criterion involving the corresponding image projections of all points.

“Composting” in this context refers to combining visual elements from separate sources into single images, often to create the illusion that all those elements are parts of the same scene.

“Decoder” in this context refers to an electronic device that converts a coded signal into one that can be used by other equipment.

“Encoder” in this context refers to a device, circuit, transducer, software program, algorithm or person that converts information from one format or code to another for the purposes of standardization, speed, secrecy, security or compressions. In some embodiments the terms encoder and multiplexer may be used interchangeably.

“FAST” in this context refers to Features from Accelerated Segment Test keypoint detection.

“Flexible electronic display” in this context refers to a display capable of being bent, turned, or forced from a substantially straight line or form without breaking and without compromising the display quality associated with well known, non-flexible LCD or LED display panel.

“Global optimization” in this context refers to finding the absolutely best set of parameters to optimize an objective function.

“Harris Corner Detector (Harris)” in this context refers to a means of using a normalized cross-correlation of intensity values to match features between images.

“HEVC” in this context refers to High Efficiency Video Coding.

“Image registration” in this context refers to the determination of a geometrical transformation that aligns points in one view of an object with corresponding points in another view of that object or another object.

“Multiplexer” in this context refers to a device allowing one or more low-speed analog or digital input signals to be selected, combined and transmitted at a higher speed on a single shared medium or within a single shared device.

“ORB” in this context refers to Oriented FAST and Rotated BRIEF (ORB), a very fast binary descriptor based on Binary Robust Independent Elementary Features (BRIEF) key point descriptor.

“Photo-stitching” in this context refers to combining a series of images to form a larger image or a panoramic photo.

“PROSAC” in this context refers to the progressive sample consensus (PROSAC) algorithm which exploits the linear ordering defined on the set of correspondences by a similarity function used in establishing tentative correspondences.

“RANSAC” in this context refers to random sample consensus (RANSAC), an iterative method to estimate parameters of a mathematical model from a set of observed data which contains outliers.

“SIFT” in this context refers to Scale-Invariant Feature Transform (SIFT), an algorithm in computer vision to detect and describe local features in images.

“SURF” in this context refers to Speeded Up Robust Features (SURF). SURF uses an integral image for fast local gradient computations on an image.

“Thin Film” in this context refers to a layer of material ranging from fractions of a nanometer (monolayer) to several micrometers in thickness.

“Video compression format” in this context refers to a content representation format for storage or transmission of digital video content.

### DESCRIPTION

Described herein is a means for reducing and/or eliminating blind spots in vehicles through the use of flexible electronic display material and exterior or interior cameras. While the motorized vehicle shown in the figures is a passenger sedan, it may also be a pickup truck, SUV, tractor trailer, bus or other motorized vehicle.

Blind spots are generally viewed as being rear quarter blind spots, areas towards the rear of the vehicle on both sides. However, they are also present at an acute angle intersection, while entering a left side or right side lane change, during a back-up maneuver, or while performing curbside parking/exiting. The use of a flexible electronic delay combined with exterior cameras may allow vehicle designers and engineers to create stronger, more rigid modes of transport by decreasing the need for windows, further increasing the safety of the vehicle.

In order to reduce and/or eliminate blind spots in vehicles, a plurality of cameras are mounted on the exterior of a vehicle or on the interior of a vehicle in areas that cause obstructions, such as the back of the rear view mirror. The cameras may protrude, may be flush mounted, or may be sunken into the side of the vehicle. In some embodiments the cameras may be placed on the exterior of the vehicle's support pillars. In additional embodiments, the cameras may be placed on the exterior casing of a car's mirrors. In further embodiments they may be placed below the exterior door latch. In yet another embodiment, they may be placed behind the mirror surface of side view mirrors, allowing for images to be taken through the glass of the mirror. In other embodiments, they may be placed all over the car. The cameras may be placed in a straight vertical line, a horizontal line, scattered, or placed in any other useful pattern for maximizing a driver's view. In some embodiments, the cameras may be placed at multiple sites on the vehicle, for example on a plurality of vehicle pillars. The passenger and driver sides of the vehicle may have the same or different numbers of cameras and/or camera placement. In some embodiments, there may be one camera per support pillar, i.e. generally four cameras on the driver side and four cameras on the passenger side of the vehicle.

Cameras may be placed on the exterior of a car so that the fields of view are independent or overlapping. In some embodiments, some fields of view may overlap while other views are independent (non-overlapping). In some embodiments, the fields of view may overlap by ⅛, ¼, ⅓, ½, ⅔, ¾ or any fraction thereof. In additional embodiments, the fields of view may overlap by about 10-50%, 10-15%, 15-20%, 10-30%, 20-30%, or less. In other embodiments, the field of view of the cameras does not overlap, but are directly adjacent to one another in a horizontal and/or vertical line. In additional embodiments, some of the fields of view may overlap and others may be adjacent to one another. In some embodiments there may be secondary cameras which are only used when the primary camera fails to capture an image whether through damage, wear and tear, obstruction of the primary cameras, or difficult light situations. Such images from the secondary cameras may be combined with or displayed in place of the primary camera images.

While any type of camera may be used, the vehicle mounted cameras as used herein generally comprise a lens and a sensor. Each camera may use any type of lens desired, including, but not limited to, wide angle, infrared, ultra-wide angle, macro, stereoscopic lens, swivel lenses, shift lenses, movable lenses, standard lens, medium telephoto lens, telephoto and/or other specialist lens. Each camera may have the same or different types of lenses from other cameras on the same pillar, used in combination with one another, or other cameras on the vehicle. The cameras may each independently have varifocal or fixed lens. Given the differences in the size and point of view of each driver and the size and angle of support pillars on different vehicles, in some embodiments the angle of view and focal point of one or more cameras may be adjustable to suit the driver's preferences.

At times, exterior conditions may be such that an accurate image cannot be captured, for example in situations of low light, because of dirt or other debris on the camera lens, or other reasons for insufficient data capture. In such instances, a warning may be displayed or sounded to alert the driver that the image is not sufficiently detailed for human discernment in a particular direction or on a particular display surface. In some embodiments, a low-lux parameter can be set to optimize viewing. For example, the camera gain and exposure may be adjusted automatically to a pre-set value or to achieve a target brightness specified by the driver. In some embodiments, the luminance of captured frames is used to adjust the camera exposure and/or gain of subsequent frames. In other embodiments, the ideal limit of the exposure in normal operating conditions may be set between the exposure settings for normal and low light conditions allowing for a minimization of motion blur. The ideal limit may be pre-set or may be adjustable, allowing the driver to optimize the lighting level at which the camera will switch to night mode.

The images from two or more cameras are processed using one or more microprocessors substantially simultaneously. In some embodiments, the images may be processed through an image signal processor or sent directly to a multiplexer or data selector. The image signal processor corrects any distortion of image data and outputs a distortion-corrected image. In some embodiments, the image signal processor receives image data from a frame buffer. The frame buffer may store all image data or only the image data needed for image distortion corrections. Selective storage allows for increased availability of space in the buffer for image storage. In some embodiments, the images are split upon reaching the screen through the use of a demultiplexer into the original multiple images which are then displayed on a screen mounted in the passenger compartment of the car. In other embodiments, the images of a single camera are sent to a single display.

In some embodiments, the images from the camera are analyzed to determine an overlapping capture region. The images are then stitched together using the overlapping capture region. For example, a first camera may take a first image and a second camera may take a second image. The first camera and second camera are positioned on the exterior of a vehicle such that a portion of the first image and a portion of the second image overlap. The first and second camera may or may not be on the same pillar or section of the vehicle. The first image and the second image are then stitched together to form a single image which is then projected on the flexible electronic screen on the interior of the pillar. In some embodiments, there is provided a non-transitory computer readable medium storing a computer program comprising instructions configured to, working with at least one processor, cause at least the following to be performed: analyzing first and second images, the first being captured by a first camera and the second image being captured by a second camera, wherein at least one position on the first and second images, at which the analysis of the first and second images is initiated depends upon at least one contextual characteristic (correspondence relationship) identified by a feature matching algorithm such as, but not limited to, SIFT, SURF, Harris, Fast, PCA-SIFT, ORB and the like; determining, from the analysis of the first and second images, an overlapping capture region for the first camera and the second camera, for example using RANSC or PROSAC algorithms; and stitching the first and second images together using the overlapping capture region. Images from two, three, four, five, six or more cameras on may be combined to form a single image in any processing and integration order. Overlapping regions of the images may be captured by two or more cameras. For example, camera one may have an overlapping region with camera two. Camera two may also have an overlapping region with camera three, but camera three does not share an overlapping region with camera one.

Images may be processed for appropriate display on the flexible electronic display, allowing for correction of the aspect ration while maintaining good resolution. In some embodiments, the images may be processed to adjust the size of the image displayed. The processing may alter the size of the image displayed in order to obtain the clearest image with the least distortion. The image may be increased or decreased in size depending on the amount of distortion. In some embodiments, the image size may be adjusted by the vehicle operator. In other embodiments, the image size may be pre-set by the manufacturer. In some embodiments, images may be processed such that the images present a constant view between surfaces displaying the images and transparent surfaces such as a window or another display.

In some embodiments, multiple images of the same scene are combined into an accurate 3D reconstruction using bundle adjustment. A globally consistent set of alignment parameters that minimize the misregistration between all pairs of images are identified. Initial estimates of the 3D location of features are computed along with information regarding the camera locations on the vehicle. An iterative algorithm is then applied to compute optimal values for the 3D reconstruction of the scene and camera positions by minimizing the log-likelihood of the overall feature projection errors using a least-squares algorithm. The images are then composted based on the shape of the projection surface.

Images taken by two or more cameras are processed, transmitted using a video compression format, and displayed real-time on one or more flexible electronic displays on the inside of the passenger compartment of the vehicle. Any video compression format can be used including, but not limited to, advanced video coding, high efficiency video coding, Dirac, VC-1, Real Video, VP8, VP9 or any other generally used compression format. The flexible electronic display may be any type of flexible display of 10 mm thickness or less generally used including, but not limited to, an organic light emitting diode (OLED), active matrix light emitting diode, super AMOLED, Super AMOLED Plus, HD Super AMOLED, HD Super AMOLED Plus, Full HD Super AMOLED Plus, WQ HD Super AMOLED, and WQXGA Super AMOLED. In some embodiments, the flexible electronic display may have a backplane of polymers, plastic, metal, or flexible glass such as, but not limtied to, polyimide film, flexible Thin-Film Field Effect Transistor (TFT), polymer organic semiconductor, small molecule organic semiconductor (OSC), metal oxide, organic thin film transistors, or any other suitable substrate. In some embodiments, the flexible display may be about 5 mm or less, about 3 mm or less, about 1 mm or less, about 0.5 mm or less, about 0.25 mm or less, about 0.2 mm or less, about 0.18 mm or less, about 0.15 mm or less, 0.1 mm or less or any subset thereof. While a flexible electronic display with any appropriate amount of flexibility may be used, in some embodiments, the flexible electronic display may bend through at least about 10° from the center of the screen, about 15°, about 20°, about 25°, about 30°, about 40°, about 50°, about 75°, about 100°, about 120°, about 130°, about 140°, about 150°, about 170° about 180°, about 220°, about 250°, about 300°, about 360° or any fraction thereof. In other embodiments, the amount of flexibility may be defined by the curvature radius such as, but not limited to, a curvature radius of at least about 3 mm, about 5 mm, about 7 mm, about 7.5 mm, about 10 mm, about 15 mm, about 20 mm, about 50 mm, about 100 mm, about 300 mm, about 400 mm, about 500 mm, about 600 mm, about 700 mm, about 800 mm, about 1000 mm or any other desired curvature radius.

Flexible electornic displays may be placed throughout the interior of the passenger compartment of a vehicle. In some embodiments, the flexible electronic display is on the dashboard. In other embodiments, the flexible electronic display is attached to all or part of the interior of the car creating the illusion that the driver and/or the passengers of the vehicle can see directly through the vehicle's walls. For example, where the B pillar is located on the driver side of the car, images taken from the exterior of the B pillar may be displayed on the interior of the B pillar. In some embodiments, flexible electronic displays may be placed on the pillars. In other embodiments, the flexible electronic display may be applied to one or more non-transparent surfaces in the interior of a vehicle including, but not limited to, the pillars, the interior mirror access cover, the roof, the doors, the headrests, the interior or any other non-transparent surface in the interior of a vehicle. In further embodiments, the flexible electronic display may be applied to transparent and/or non-transparent surfaces in the interior of a vehicle. In other embodiments, the flexible electronic displays are placed on any surface that may interfere with a driver's view of objects or events occurring outside of the vehicle. In some embodiments, multiple flexible electronic displays may be applied in a vertical and/or horizontal line to provide the desired display size. In additional embodiments, such as in an articulated vehicle, the flexible electronic display may be applied to the interior of the driver's cab, including behind the driver such that the driver has a view of the exterior of the articulated vehicle. In further embodiments, a single display may be placed on each pillar. In yet another embodiment, a series of displays may be applied in an horizontal or vertical line such that each camera is linked to a single display, but displays as a whole may be combined to display a greater view than would be possible from an individual camera. In additional embodiments, the flexible electronic displays may be used to display images other than those from the cameras on the exterior of the vehicles. For example, the displays may be used to present traffic information, alerts, still images, pre-formatted video and the like.

Most cars have air bags or air curtains in one or more of the vehicle pillars. In some embodiments, flexible electronic displays may be designed to break away when an air bag deploys. For example, in some embodiments, the flexible electronic display screen may be affixed to a pillar containing an air bag. One or more of the attachment points of the flexible electronic display screen may be scored or otherwise perforated allowing the flexible electronic display to detach from the vehicle pillar along at least one edge in the event of an air bag deployment. In some embodiments, the flexible electronic display may be attached using tabs or attachment mechanisms located behind the fascia of the vehicle pillar. The flexible electronic display may be perforated along the tabs behind the fascia. In other embodiments, the flexible electronic display may be perforated on the surface of the fascia or at any other useful place on the display suitable to prevent the display from interfering with airbag deployment. For example, in some embodiments, the flexible display may be perforated down and/or across the middle with each side or corner anchored to the pillar thereby minimizing the size, force and/or addition of any additional projectiles in an accident. The flexible electronic display may be attached to the vehicle pillar using any type of attachment means or attachment device including, but not limited to, automotive industrial adhesives, fascia or pillar lining clips, screws, brads, rivets, or other types of suitable adhesives or fastening mechanisms.

The images displayed on the flexible electronic display may be of a fixed perspective or may alter depending on the point of view of the driver. In some embodiments, a sensor may determine the driver's head position and alter the display correspondingly. For example, if a driver looks over their left shoulder, the display may change to reflect what the driver would see at that angle, i.e. to the left and back and not what is directly outside of the car on the left hand side. In other embodiments, the angle of the camera may alter based on the position of the steering wheel.

### DRAWINGS

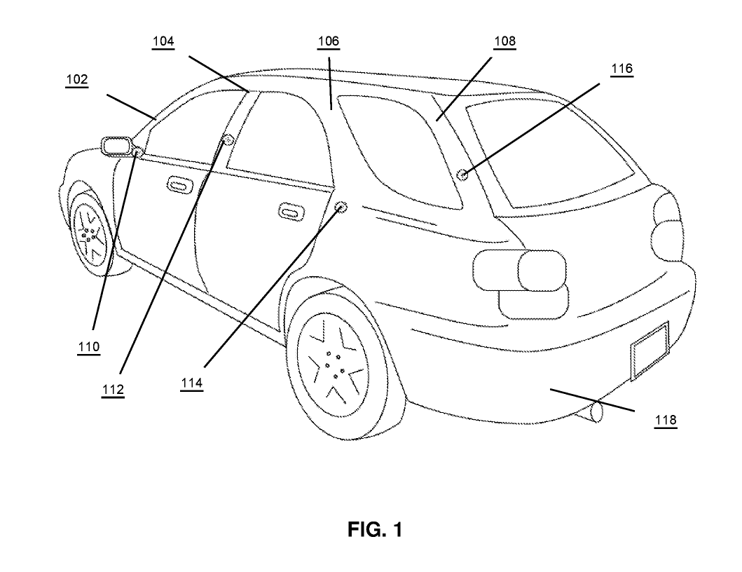

Referring to FIG. 1, a vehicle 118 has a plurality of pillars. Pillars are the vertical or near vertical supports of an automobile's window area. The vehicle 118 has an A pillar 102, a B pillar 104, a C pillar 106 and a D pillar 108. Each pillar may have mounted thereon one or more cameras 110, 112, 114 and 116 respectively. The number of cameras on a particular pillar may be the same or different as the number of cameras on any other pillar. In some embodiments, the cameras be placed on other parts of the vehicle such as the doors, the bumpers, or any other part of the vehicle where a blind spot may be an issue mitigated by use of a camera view.

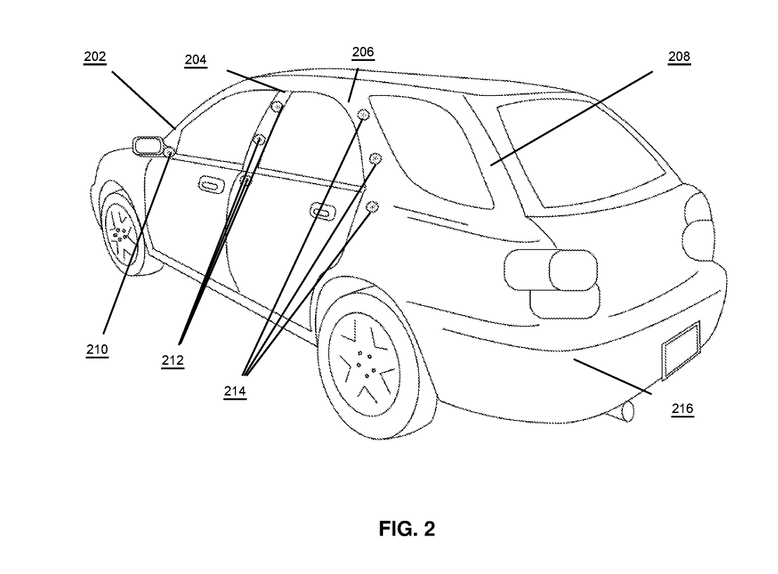

Referring to FIG. 2, a vehicle 216 has a plurality of pillars. Pillars are the vertical or near vertical supports of an automobile's window area. The vehicle 216 has an A pillar 202, a B pillar 204, a C pillar 206, and a D pillar 208. Each pillar may have mounted thereon one or more cameras 110, 112 and 114 respectively. The number of cameras on a particular pillar may be the same or different as the number of cameras on any other pillar. In some embodiments, the cameras be placed on other parts of the vehicle such as the doors, the bumpers, or any other part of the vehicle where a blind spot may be an issue mitigated by use of a camera view.

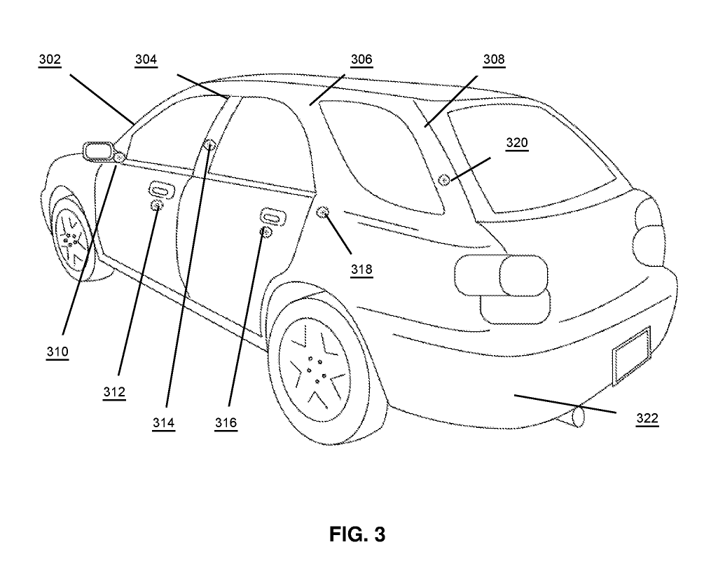

Referring to FIG. 3, a vehicle 322 has a plurality of pillars. Pillars are the vertical or near vertical supports of an automobile's window area. The vehicle 322 has an A pillar 302, a B pillar 304, a C pillar 306 and a D pillar 308. Each pillar may have mounted thereon one or more cameras 310, 314, 318 and 320 respectively. The number of cameras on a particular pillar may be the same or different as the number of cameras on any other pillar. Additional cameras may be placed on alternate parts of the vehicle such as below the door handles at 312 and 316 or on any other part of the of the vehicles where a blind spot may be an issue mitigated by the use of a camera view.

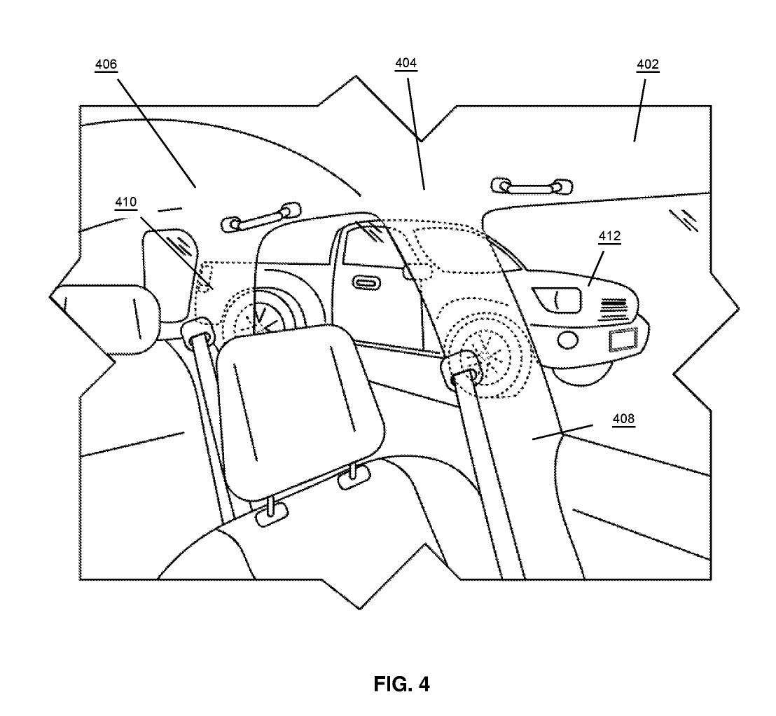

Referring to FIG. 4, in the interior of a vehicle 402 pillar B 404 and pillar C 406 are covered with one or more flexible electronic screens 408 and 410 respectively allowing the driver and the passengers to view objects exterior of the vehicle such as the truck 412 which are partially or completely obstructed by blind spots of the vehicle.

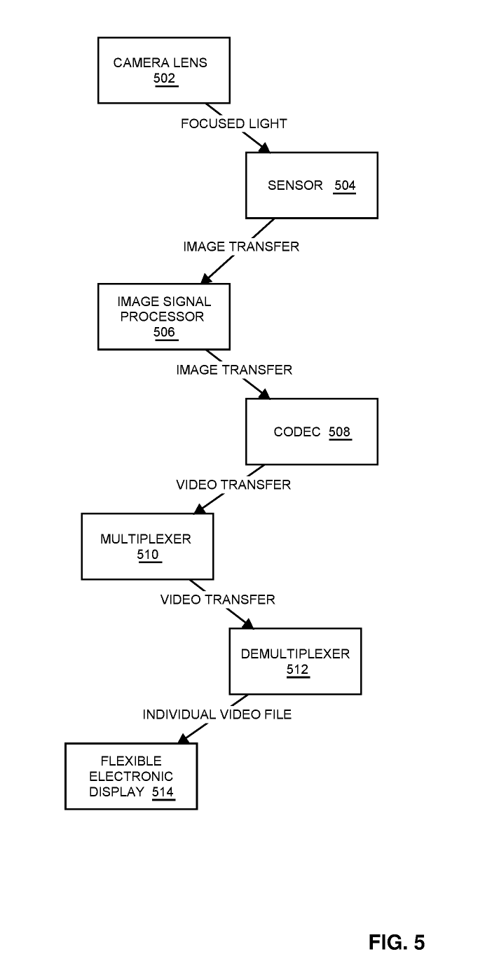

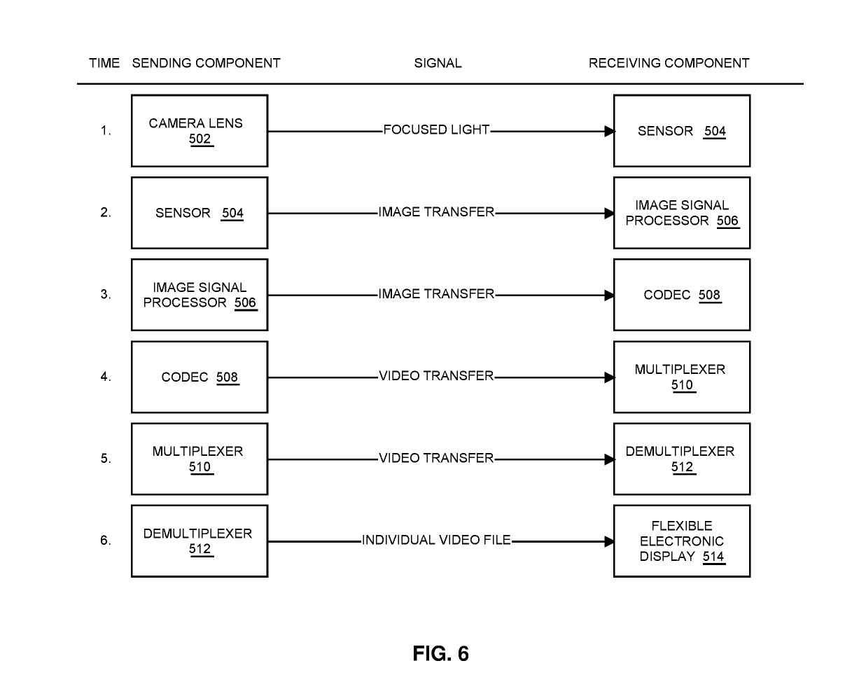

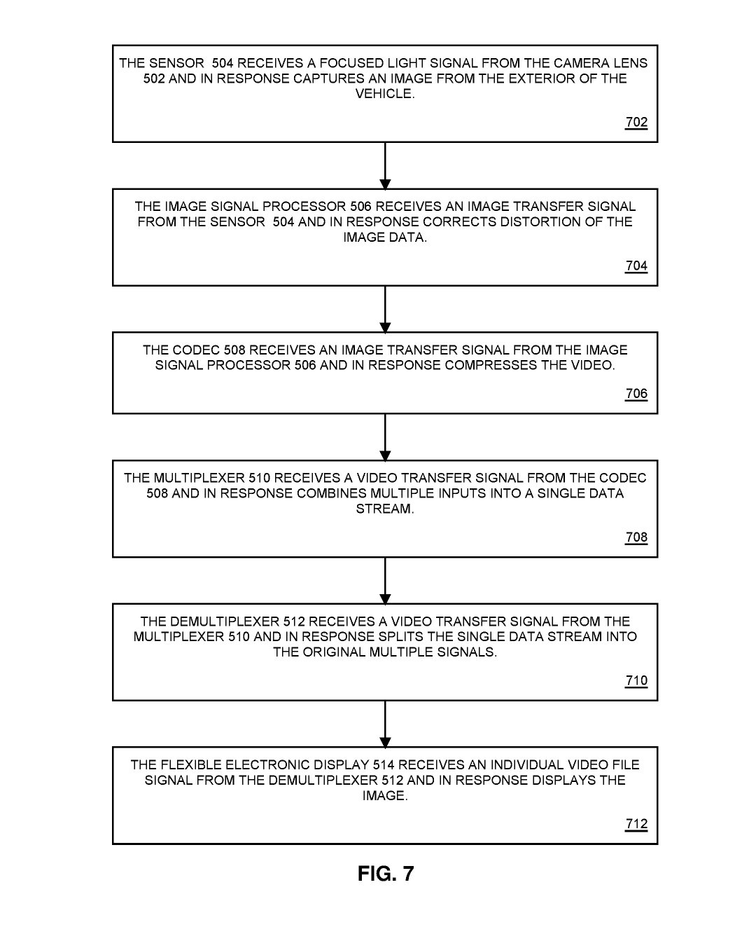

FIG. 5 is a system diagram of an embodiment of a blind spot eliminator. FIG. 6 is an action flow diagram of an embodiment of a blind spot eliminator. FIG. 7 is a flow chart of an embodiment of a blind spot eliminator.

The system comprises camera lens 502, sensor 504, image signal processor 506, codec 508, multiplexer 510, demultiplexer 512, and flexible electronic display 514. The sensor 504 receives a focused light signal from the camera lens 502 and in response captures an image from the exterior of the vehicle (702). The image signal processor 506 receives an image transfer signal from the sensor 504 and in response corrects distortion of the image data (704). The codec 508 receives an image transfer signal from the image signal processor 506 and in response compresses the video (706). The multiplexer 510 receives a video transfer signal from the codec 508 and in response combines multiple inputs into a single data stream (708). The demultiplexer 512 receives a video transfer signal from the multiplexer 510 and in response splits the single data stream into the original multiple signals (710). The flexible electronic display 514 receives an individual video file signal from the demultiplexer 512 and in response displays the image (712).

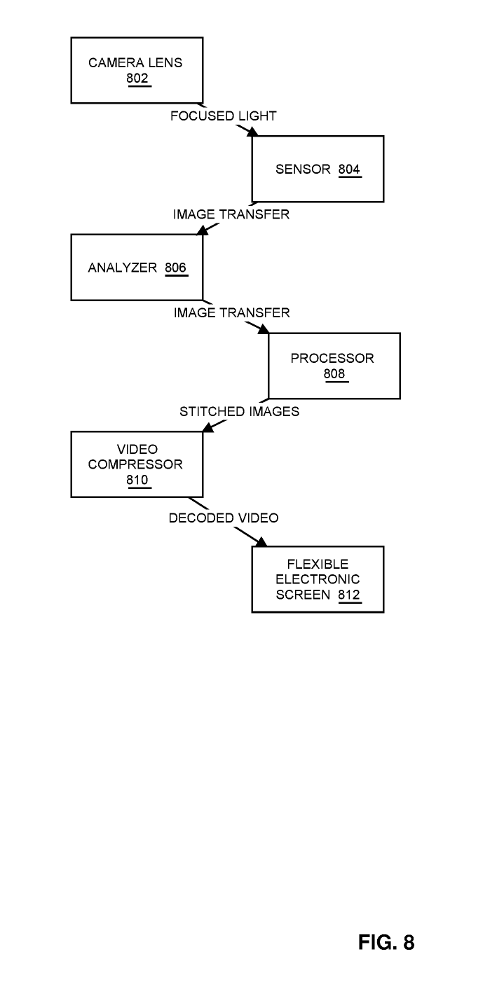

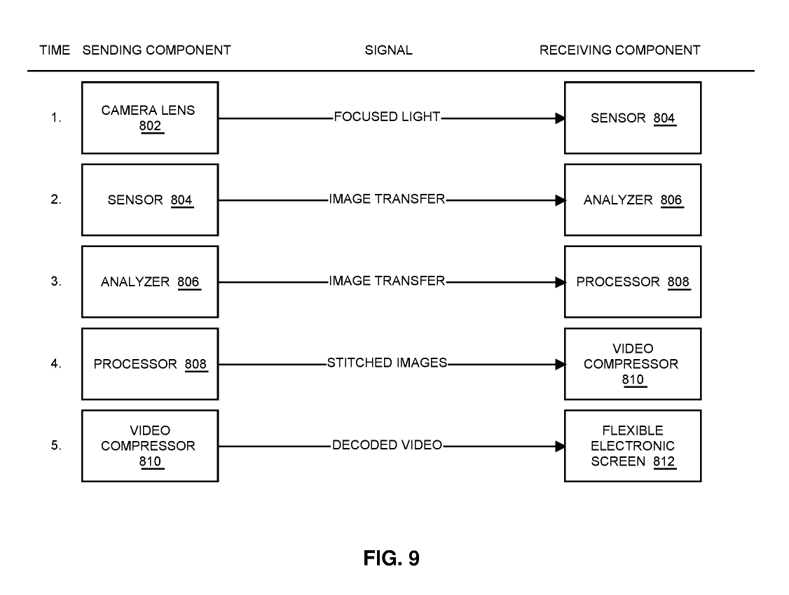

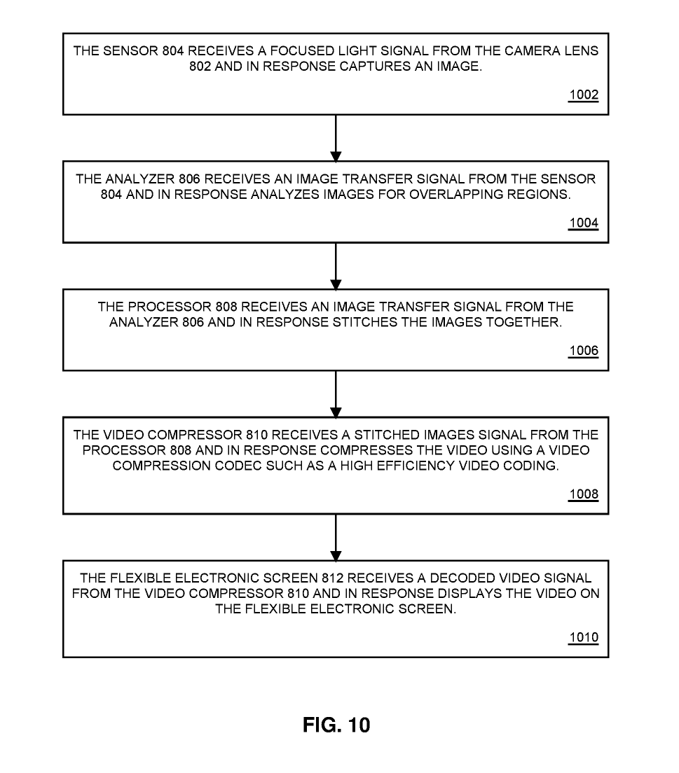

FIG. 8 is a system diagram of a system for analyzing blind spots. FIG. 9 is an action flow diagram of a system for analyzing blind spots. FIG. 10 is a flow chart of an embodiment of a system for analyzing blind spots.

The system comprises camera lens 802, sensor 804, analyzer 806, processor 808, video compressor 810, and flexible electronic screen 812. The sensor 804 receives a focused light signal from the camera lens 802 and in response captures an image (1002). The analyzer 806 receives an image transfer signal from the sensor 804 and in response analyzes images for overlapping regions (1004). The processor 808 receives an image transfer signal from the analyzer 806 and in response stitches the images together (1006). The video compressor 810 receives a stitched images signal from the processor 808 and in response compresses the video using a video compression codec such as a high efficiency video coding (1008). The flexible electronic screen 812 receives a decoded video signal from the video compressor 810 and in response displays the video on the flexible electronic screen (1010).

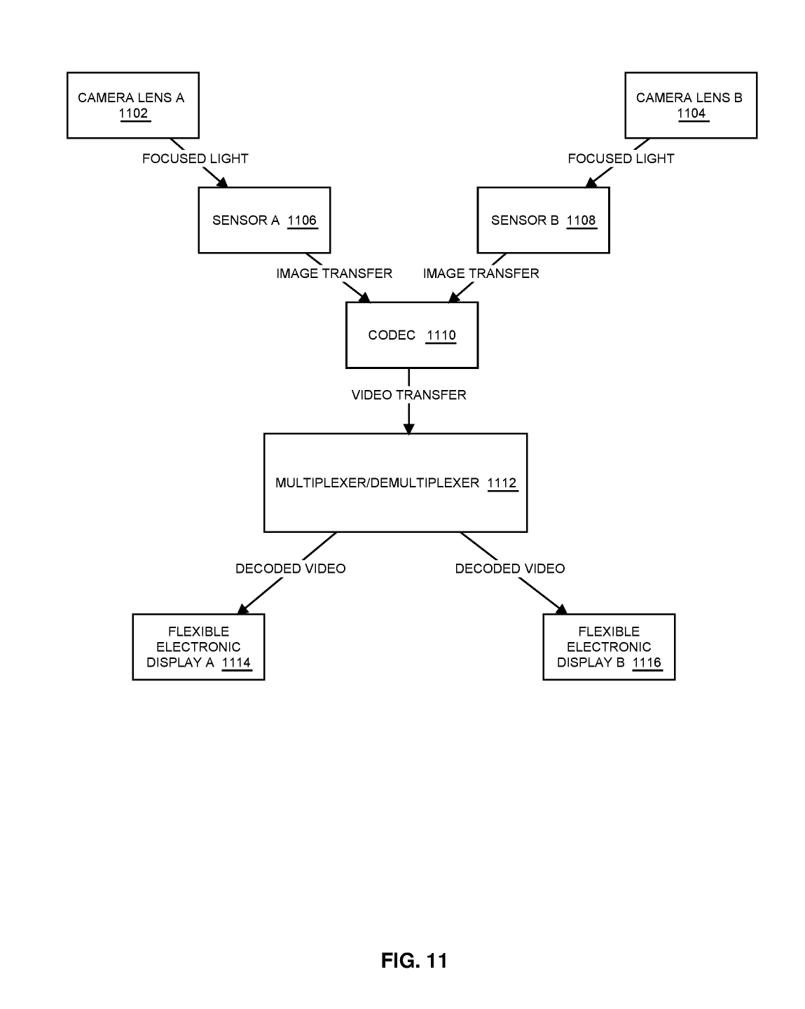

Referring to FIG. 11, the system comprises camera lens A 1102 and camera lens B 1104, though n camera lens may be used, sensor A 1106 and sensor B 1108, or as many sensors as there are camera lenses, a codec 1110, a multiplexer/demultiplexer 1112, and flexible electronic display A 1114 and flexible electronic display B 1116 though any number of flexible electronic displays may be used. The sensors A and B receive a focused light signal from the respective camera lens A and B and the image is recorded. The images are then transferred to the codec 1110 for processing and the resulting video is transferred to a multiplexer/demultiplexer and then distributed to the correct flexible electronic display such that each electronic display shows images taken immediately exterior of the car at the position of the interior electronic display.

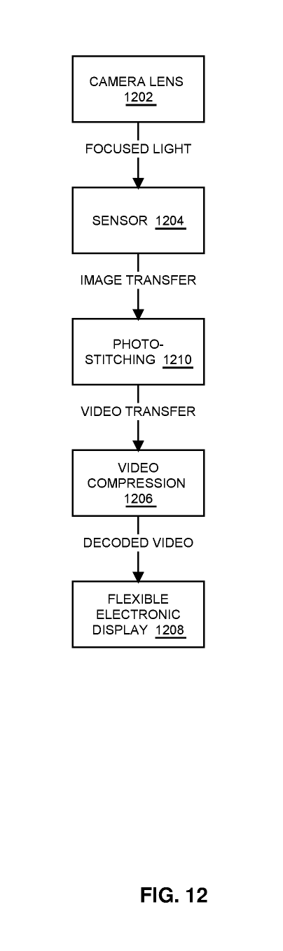

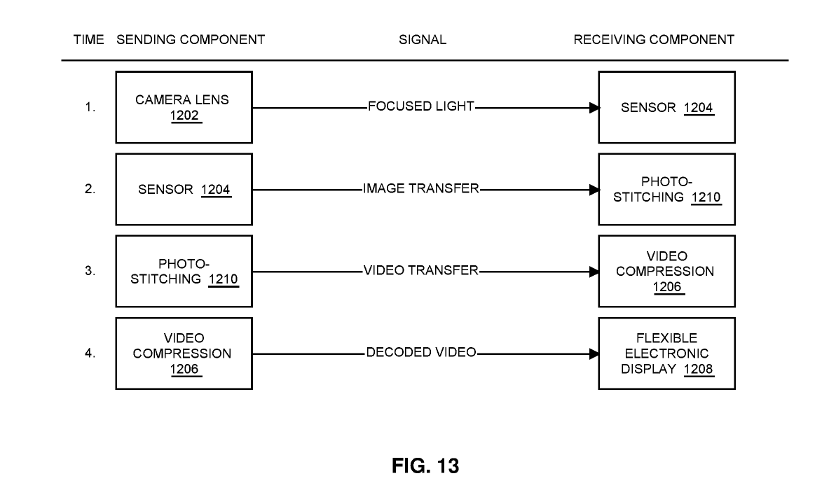

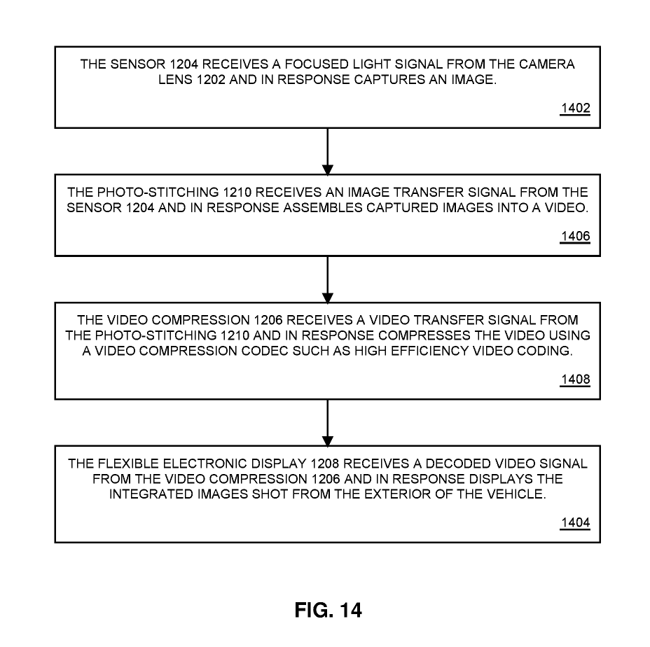

FIG. 12 is a system diagram of an embodiment of a blind spot eliminator. FIG. 13 is an action flow diagram of an embodiment of a blind spot eliminator. FIG. 14 is a flow chart of an embodiment of a blind spot eliminator.

The system comprises camera lens 1202, sensor 1204, video compression 1206, flexible electronic display 1208, and photo-stitching 1210. The sensor 1204 receives a focused light signal from the camera lens 1202 and in response captures an image (1402). The photo-stitching 1210 receives an image transfer signal from the sensor 1204 and in response assembles captured images into a video (1406). The video compression 1206 receives a video transfer signal from the photo-stitching 1210 and in response compresses the video using a video compression codec such as high efficiency video coding (1408). The flexible electronic display 1208 receives a decoded video signal from the video compression 1206 and in response displays the integrated images shot from the exterior of the vehicle (1404).

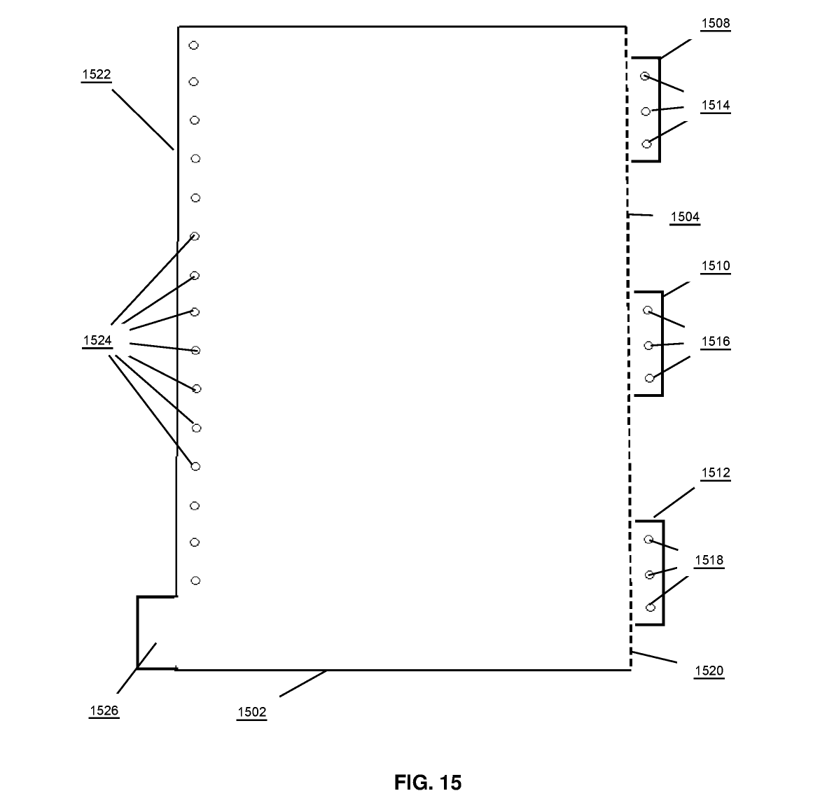

Referring to FIG. 15, a flexible electronic display screen 1502 shaped to fit vehicle pillars is scored along an edge 1520. The flexible electronic display screen 1502 is attached to a longitudinal edge of a pillar using attachment tabs 1508, 1510 and 1512 which wrap behind the fascia of the vehicle pillars and are attached to either the fascia or the pillar. The attachment tabs 1508, 1510, and 1512 may be attached using any type of adhesive or fastener. In some embodiments, the attachment tabs are attached at attachment points 1514, 1516 and 1518 respectively. At 1522, the opposite edge from the scored edge 1520, the flexible electronic display screen 1502 is attached to the opposite longitudinal edge of a pillar from the point of attachment for the attachment tabs 1508, 1510 and 1518. The opposite edge 1522 may be attached to the fascia and/or the vehicle pillar through a plurality of attachment points 1524. The display is attached to the video processor at a connection point, integrated circuit or flex cable 1526.

It will be readily understood that the components of the system as generally described and illustrated in the figures herein, could be arranged and designed in a wide variety of different configurations. Elements of embodiments described above may be embodied in hardware, firmware and/or software. While exemplary embodiments revealed herein may only describe one of these forms, it is to be understood that one skilled in the art would be able to effectuate these elements in any of these forms while resting within the scope of the present invention.

Embodiments of a blind spot elimination system have been described. The following claims are directed to said embodiments, but do not preempt blind spot elimination in the abstract. Those having skill in the art will recognize numerous other approaches to blind spot elimination are possible and/or utilized commercially, precluding any possibility of preemption in the abstract. However, the claimed system improves, in one or more specific ways, the operation of a machine system for blind spot elimination, and thus distinguishes from other approaches to the same problem/process in how its physical arrangement of a machine system determines the system's operation and ultimate effects on the material environment.

What is claimed is:

1. A means for eliminating blind spots on and increasing safety in a motorized vehicle comprising:
a plurality of cameras mounted on an exterior of a plurality of vehicle pillars on the motorized vehicle;
a plurality of perforated flexible electronic screens mounted on an interior of a passenger compartment of the motorized vehicle;
a microprocessor in communication with each of the plurality of cameras and the flexible electronic screens which continuously processes images received from each of the plurality of cameras and transmits the image from each of the plurality of cameras to the designated flexible electronic screen; and
wherein the flexible electronic screens displays the images taken immediately exterior of the motorized vehicle corresponding to an interior placement of the flexible electronic screen allowing for a consistent view between the images on the flexible electronic screens and a transparent surface adjacent to the flexible electronic screens.

2. The means of claim 1, wherein the images from the plurality of cameras are taken substantially simultaneously.

3. The means of claim 1, wherein the flexible electronic screen is an active-matrix organic light-emitting diode (AMOLED) screen.

4. The means of claim 1, wherein the image is displayed on the flexible electronic screen in real time.

5. The means of claim 4, wherein the flexible electronic screen is an AMOLED screen.

6. The means of claim 1, wherein each of the plurality of cameras comprises a lens and a sensor.

7. The means of claim 6, wherein the plurality of cameras each have a same type of lens.

8. The means of claim 6, wherein each of the plurality of cameras have different types of lenses.

9. The means of claim 6, wherein at least one of the plurality of cameras has an infrared lens.

10. The means of claim 6, wherein at least one of the plurality of cameras has a wide angle lens.

11. A means for eliminating blind spots on a vehicle comprising,
a plurality of cameras mounted on an exterior of a vehicle pillar;
a flexible electronic screen mounted on an interior of the vehicle pillar;
and at least one processor;
wherein the processor analyzes a first image taken by a first camera on the vehicle pillar and a second image taken by a second camera on the vehicle pillar;
determines an overlapping capture region from the first image and the second image; stitches the first and second images together using the overlapping capture region; and
displays a resulting image on the flexible electronic screen.

12. The means of claim 11, wherein the first image and the second image are taken substantially simultaneously.

13. The means of claim 11, wherein the flexible electronic screen is an active-matrix organic light-emitting diode (AMOLED) screen.

14. The means of claim 11, wherein the resulting image is displayed on the flexible electronic screen in real time.

15. The means of claim 11, wherein a third image taken by a third camera is stitched with the first image and the second image using the overlapping capture region on either the first image or the second image.

16. A system for preventing blind spots on a motorized vehicle comprising:
a plurality of cameras comprising a camera lens and a sensor;
a processor for stitching a first plurality of images together into stitched images;
a video compressor for compressing images;
a flexible electronic screen on an interior of a passenger compartment of the motorized vehicle for displaying at least a portion of the images; and
wherein the first plurality of images are stitched together into the stitched images using overlapping regions of the first plurality of images to form a single image taken by the plurality of cameras.

17. The system of claim 16, wherein the plurality of cameras have a same or different camera lenses.

18. The system of claim 16, wherein the flexible electronic screen is an AMOLED screen.

19. The system of claim 16, wherein the flexible electronic screen is on a surface of a pillar facing an interior of the passenger compartment of the motorized vehicle.

20. The system of claim 19, wherein the first plurality of images are displayed on the flexible electronic screen in real time.
